(19) United States
(12) Patent Application Publication
(10) Pub. No.: US 2025/0164739 A1
(43) Pub. Date: May 22, 2025

(54) OPTICAL ELEMENT DRIVING MECHANISM

(71) Applicant: TDK TAIWAN CORP., Taoyuan City (TW)

(72) Inventors: Po-Xiang ZHUANG, Taoyuan City (TW); Wei-Jhe SHEN, Taoyuan City (TW); Sin-Jhong SONG, Taoyuan City (TW); Ko-Lun CHAO, Taoyuan City (TW); Yi-Ho CHEN, Taoyuan City (TW)

(21) Appl. No.: 18/949,768

(22) Filed: Nov. 15, 2024

Related U.S. Application Data
(60) Provisional application No. 63/600,363, filed on Nov. 17, 2023.

(51) Int. Cl. G02B 7/08; G02B 27/64

(52) U.S. Cl. CPC G02B 7/08; G02B 27/646

(57) ABSTRACT

An optical element driving mechanism is provided. The optical element driving mechanism includes a first movable part, a fixed part, and a driving assembly. The first movable part is used for connecting a first optical element. The first movable part moves relative to the fixed part. The driving assembly is used for driving the first movable part to move.

### CROSS REFERENCE TO RELATED APPLICATIONS

This application claims the benefit of U.S. Provisional Application No. 63/600,363, filed 2023 Nov. 17, the entirety of which is incorporated by reference herein.

### BACKGROUND OF THE INVENTION

### Field of the Invention

The present invention relates to an optical element driving mechanism, and, in particular, to an optical element driving mechanism with multiple driving parts and multiple movable parts.

### Description of the Related Art

With the development of technology, many electronic devices today (such as laptops, smartphones, or digital cameras) are equipped with photography or video recording functions. The use of these electronic devices has become increasingly common. In addition to developing better optical quality that is more stable, the design is also moving towards convenience and miniaturization, providing users with more options.

In view of this, there is a need for an optical element that allows for adjustment of the optical focusing distance to adapt to different external photography needs. At the same time, it should be compatible with a variety of optical modules to enhance versatility. Additionally, it should have a stable internal structure to provide better optical quality that is more stable.

### BRIEF SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate parts of the entire specification of this disclosure, any or all drawings, and each claim.

According to certain aspects of the present disclosure, an optical element is provided. The optical element driving mechanism includes a first movable part, a fixed part, and a driving assembly. The first movable part is used for connecting a first optical element. The first movable part moves relative to the fixed part. The driving assembly is used for driving the first movable part to move.

According to certain aspects of the present disclosure, the driving assembly includes a first driving part and a circuit part. The first driving part drives the first movable part to move in a first dimension. The circuit part is electrically connected to the first driving part. The first driving part is electrically connected to a first external circuit via the circuit part.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a perspective view of an optical element driving mechanism, according to certain aspects of the present disclosure.

FIG. 2A is an exploded perspective view of an example optical element driving mechanism, according to certain aspects of the present disclosure.

FIG. 2B is a schematic view of the first driving part and circuit part of the optical element driving mechanism in FIG. 2A, according to certain aspects of the present disclosure.

FIG. 3A is an exploded perspective view of another example optical element driving mechanism, according to certain aspects of the present disclosure.

FIG. 3B is a perspective view of the first driving part and circuit part of the optical element driving mechanism in FIG. 3A, according to certain aspects of the present disclosure.

FIG. 4 is a side view of an optical element driving mechanism, according to certain aspects of the present disclosure, wherein for illustrative purposes, the case is removed, and the bottom is shown in dashed lines.

FIG. 5 is a top view of an optical element driving mechanism, according to certain aspects of the present disclosure, wherein for illustrative purposes, the case is removed, and the first driving part and circuit part are shown in dashed lines.

### DETAILED DESCRIPTION OF THE INVENTION

Various embodiments are described with reference to the accompanying drawings, wherein like reference characters are used to designate similar or equivalent elements throughout. The drawings are not to scale and are provided solely to illustrate features and characteristics of the present disclosure. It is understood that many specific details, relationships, and methods are set forth to provide a comprehensive understanding. However, one of ordinary skill in the art will readily recognize that various embodiments may be practiced without one or more of the specific details or in other ways. In some instances, well-known structures or operations are not shown in detail for illustrative purposes. Various embodiments are not limited to the order in which actions or events are displayed, as some actions may occur in a different order and/or concurrently with other actions or events. Furthermore, not all actions or events shown may be required to implement certain aspects and characteristics of the present disclosure.

For the purposes of this embodiment, unless expressly stated otherwise, the singular includes the plural and vice versa. The term “including” means, “including without limitation”. In addition, similar words such as “about (bout, almost, substantially, approximately)” and similar words may here mean, for example, “at”, “near, nearly at”, “at 3% “Within 3-5% of”, “within acceptable manufacturing tolerances” or any logical combination thereof. Additionally, the terms “vertical” or “horizontal” are intended to additionally include “within 3-5%” of the vertical or horizontal direction, respectively. In addition, directional terms such as “top,” “bottom,” “left,” “right,” “above,” and “below” are intended to relate to the equivalent directions depicted in the reference illustration; from the reference object or component Understood in context, such as from the usual position of the object or element; or such other description.

It will be understood that, although the terms “first”, “second”, etc. may be used herein to describe various elements, layers and/or portions, these elements, layers and/or portions should not be referred to as such. The terms are limited and are only used to distinguish between different components, layers and/or sections. Thus, a first element, layer and/or section discussed below could be termed a second element, layer and/or section without departing from the teachings of some embodiments of the present disclosure. In addition, for the sake of simplicity, terms such as “first” and “second” may not be used to distinguish different components in the specification. Without departing from the scope defined in the appended patent application, the first element and/or the second element described in the patent application may be interpreted as any element consistent with the description in the specification.

It should be noted that the technical solutions provided by the different embodiments in the following text may be exchanged, combined, or mixed, to form another embodiment without departing from the spirit of the present disclosure.

The present disclosure relates to an optical element driving mechanism, which includes a driving assembly; the driving assembly includes a first driving part and a second driving part. The first driving part and the second driving part drive the movement of a first movable part, a second movable part, and optical elements, thereby adjusting the optical imaging of the optical element driving mechanism to meet various photography needs.

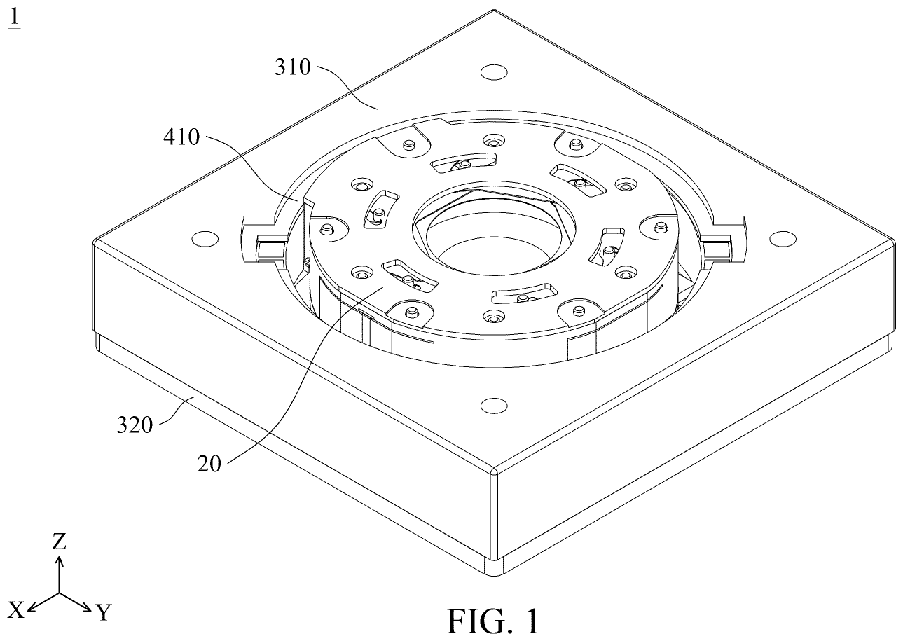

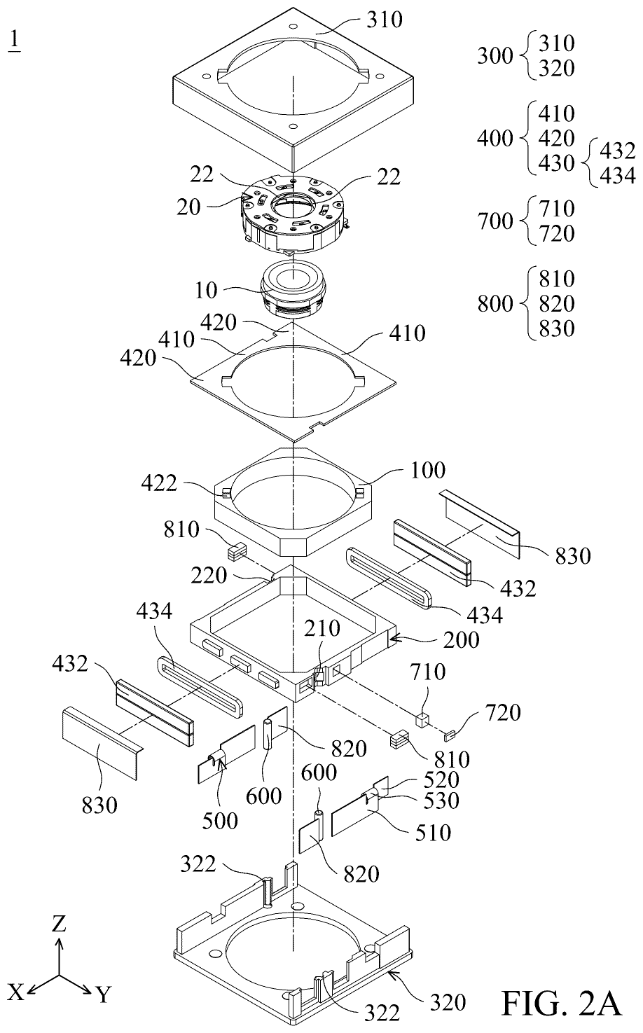

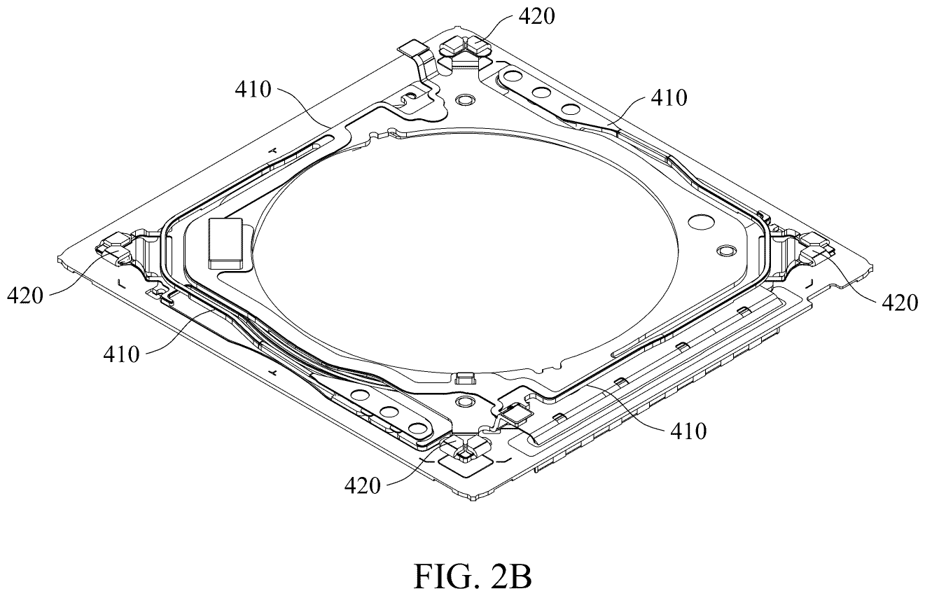

First, please refer to FIG. 1 to FIG. 2A, FIG. 1 is a perspective view of an optical element driving mechanism 1 according to certain aspects of the present disclosure.

FIG. 2A is an exploded perspective view of an exemplary optical element driving mechanism 1, according to certain aspects of the present disclosure.

The optical element driving mechanism 1 includes a first movable part 100, a second movable part 200, a fixed part 300, a driving assembly 400, a plurality of electronic components 500, a plurality of guide rods 600, a sensing assembly 700, and a stabilizing assembly 800. The first movable part 100 is used for connecting a first optical element 10. The first optical element 10 may be, for example, an optical lens. The first movable part 100 is movable relative to the fixed part 300. The driving assembly 400 is used for driving the movement of the first movable part 100 and the second movable part 200. The first movable part 100 and the second movable part 200 may move relative to the fixed part 300.

Incident light from the outside passes through the optical element driving mechanism 1 in an incident direction (i.e., the Z-axis direction) and reaches the first optical element 10. The first optical element 10 is disposed on the optical element driving mechanism 1 to achieve autofocus (AF) and optical image stabilization (OIS) functions through the optical element driving mechanism 1.

The second movable part 200 includes a first groove 210 and a second groove 220. The first groove 210 has a V-shaped form to accommodate one of the guide rods 600. The second groove 220 has a U-shaped form to accommodate another guide rod 600.

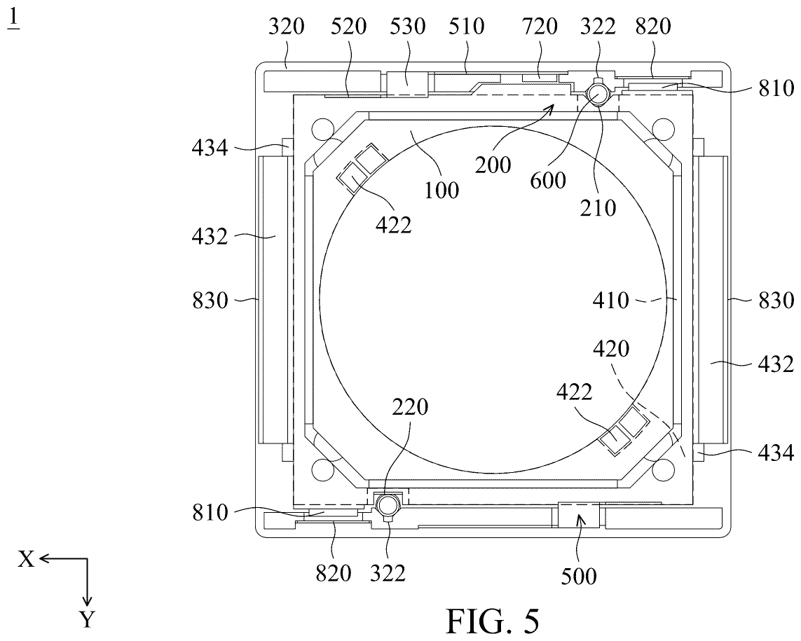

The fixed part 300 includes a case 310 and a bottom 320. The bottom 320 has a plurality of receiving parts 322 that house the guide rods 600. In this embodiment, there are two guide rods 600, so the bottom 320 also includes two receiving parts 322 (the relative movement between the guide rods 600, the second movable part 200, and the bottom 320 will be described in more detail below with respect to FIG. 2A and FIG. 5).

The driving assembly 400 includes a first driving part 410, a circuit part 420, and a second driving part 430. The first driving part 410 drives the first movable part 100 to move in a first dimension. The circuit part 420 electrically connects the first driving part 410. The first movable part 100 is connected to the second movable part 200 via the first driving part 410 and the circuit part 420. When observed along the direction perpendicular to the direction of the incident light (i.e., in the X or Y axis direction), the first driving part 410 and the circuit part 420 are positioned between the first movable part 100, the second movable part 200, and the optical module 20. The second driving part 430 drives the second movable part 200 to move in a second dimension.

In this embodiment, the first driving part 410 is made of a material such as shape memory alloy (SMA), and its length may be changed by applying a driving signal (e.g., current) from an external power source (not shown).

For example, when the driving signal reaches the first driving part 410 via the circuit part 420 and causes the first driving part 410 to heat up, the first driving part 410 deforms and either elongates or shortens. When the driving signal is no longer applied, the first driving part 410 returns to its original length. In other words, by applying the appropriate driving signal, the length of the first driving part 410 may be controlled to move the first movable part 100 relative to the fixed part 300, thereby driving the movement of the first optical element 10. This allows the optical element driving mechanism 1 to provide focusing, optical image stabilization (OIS), or shake compensation functions.

The circuit part 420 may be made of materials such as spring plates or fixed plates. The first driving part 410 is electrically connected to a first external circuit (not shown, for example, a circuit that outputs from the first driving part 410) through the circuit part 420. The circuit part 420 includes a connecting circuit 422, which may be, for example, a wire clamp or a spring formed from shape memory alloy. The connecting circuit 422 is at least partially fixed on the first movable part 100.

The circuit part 420 may be electrically connected to a second external circuit (not shown) either directly or indirectly, which may be, for example, a circuit that outputs to another module, such as the optical module described below. The second external circuit is connected to an optical module 20, which may be, for example, an aperture. The optical module carries second optical elements 22, which could be, for example, a plurality of blades that form the aperture.

Next, please refer to FIG. 2A through FIG. 2B. FIG. 2B is a schematic diagram of the first driving part 410 and circuit part 420 of the optical element driving mechanism 1 shown in FIG. 2A, according to certain aspects of the present disclosure.

FIG. 2A through FIG. 2B show an example configuration of the first driving part 410 and circuit part 420 of the optical element driving mechanism 1.

In this embodiment, the first driving part 410 is located above the first movable part 100. The first driving part 410 consists of four shape memory alloy wires, each connected to the circuit part 420. The optical module 20 may be connected to the electronic components 500 through the circuit part 420.

The movement in this configuration works as follows: the first driving part 410 deforms when receiving a driving signal through the circuit part 420, displacing in the X-axis and Y-axis plane directions. As a result, the first driving part 410 drives the first movable part 100 to move in the first dimension along the X-axis and Y-axis plane.

When viewed along the direction of the incident light (i.e., the Z-axis direction), the case 310, the first driving part 410, and the first movable part 100, and bottom 320 are arranged sequentially.

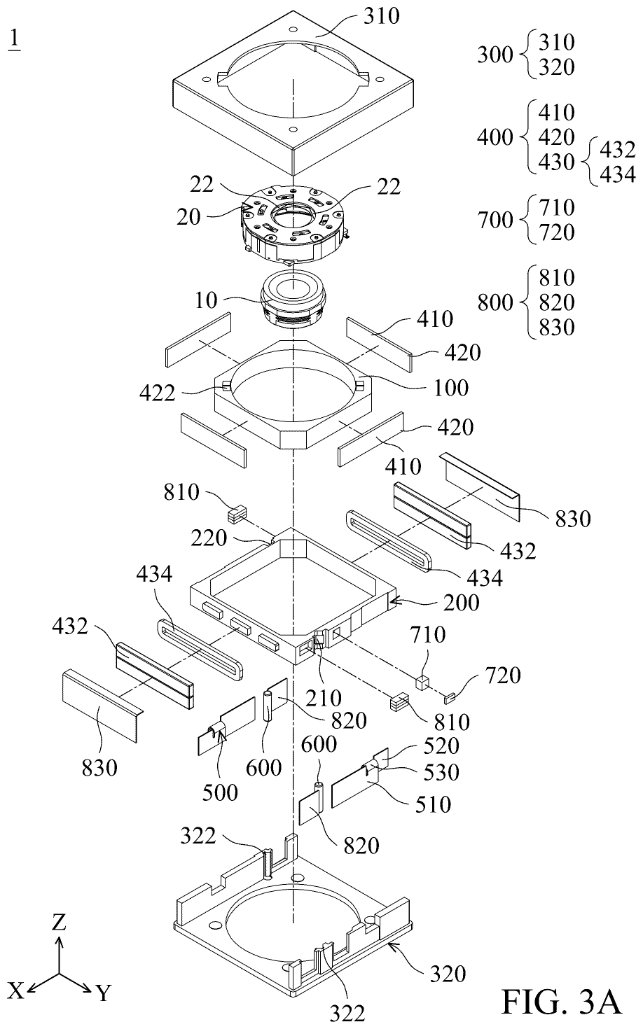

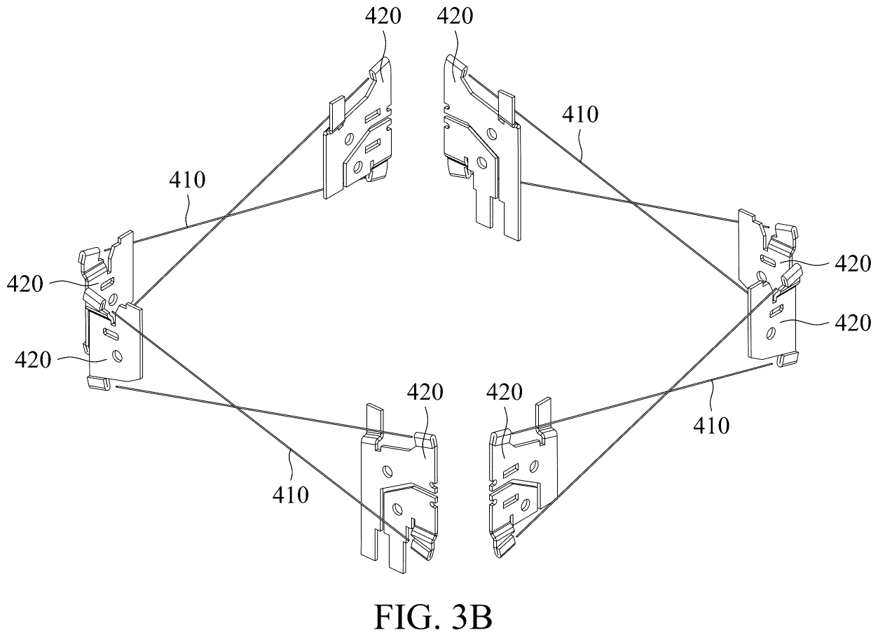

Next, refer to FIG. 3A through FIG. 3B. FIG. 3A is an exploded perspective view of another example optical element driving mechanism 1, according to certain aspects of the present disclosure. FIG. 3B is a perspective view of the first driving part 410 and circuit part 420 of the optical element driving mechanism 1 shown in FIG. 3A, according to certain aspects of the present disclosure.

In this embodiment, the first driving part 410 is located between the first movable part 100 and the second movable part 200. The first driving part 410 consists of eight shape memory alloy wires, each connected to the circuit part 420. In this embodiment, the optical module 20 may be connected to the first driving part 410 through the connecting circuit 422 of the circuit part 420, which is further connected to the electronic components 500 via the first driving part 410. Then, the electronic component 500 is electrically connected to an external driving circuit (not shown) via an insert-molded circuit structure (not shown) within the base 320. In other words, the shape memory alloy of the first driving part 410 is a conductive material.

The movement in this configuration works as follows: the first driving part 410 deforms when receiving a driving signal through the circuit part 420, expanding and contracting in both the X-axis and Z-axis plane direction, as well as the Y-axis and Z-axis plane direction, thereby enabling both displacement and rotation. As a result, the first driving part 410 drives the first movable part 100 to move in the first dimension of the X-axis, Y-axis, and Z-axis directions. The first movable part 100 is connected to the second movable part 200 via the first driving part 410 and the circuit part 420. When observed along the incident direction of the incident light (i.e., the Z-axis direction), the first driving part 410 and the circuit part 420 are positioned between the first movable part 100 and the second movable part 200.

The second driving part 430 is located between the second movable part 200 and the fixed part 300. The second driving part 430 includes a plurality of driving magnetic elements 432 and a plurality of driving coils 434.

In this embodiment, two driving magnetic elements 432 and two driving coils 434 are included. The driving magnetic elements 432 are located on the bottom 320 of the fixed part 300. The driving coils 434 are located on the second movable part 200. In other embodiments, the driving magnetic elements 432 could also be placed on the second movable part 200, and the driving coils 434 could be placed on the fixed part 300.

By the electromagnetic driving force generated between the driving magnetic elements 432 and the driving coils 434, the driving coils 434 move relative to the driving magnetic elements 432. As a result, the second movable part 200 moves relative to the bottom 320 of the fixed part 300 in the second dimension, which is the Z-axis direction. The second movable part 200 drives the movement of the first movable part 100, the first optical element 10, and the second optical element 22. Therefore, the electromagnetic driving force between the driving magnetic elements 432 and the driving coils 434 may drive the second movable part 200, which in turn moves the first movable part 100, the first optical element 10, and the second optical element 22 in the second dimension relative to the bottom 320 of the fixed part 300.

The electronic components 500 include a first part 510, a second part 520, and an intermediate part 530. The first part 510 is connected to the bottom 320 of the fixed part 300. The second part 520 is connected to the second movable part 200. The intermediate part 530 is made of flexible material and has a bent shape that spans across the bottom 320 of the fixed part 300, connecting the bottom 320 of the fixed part 300 to the second movable part 200.

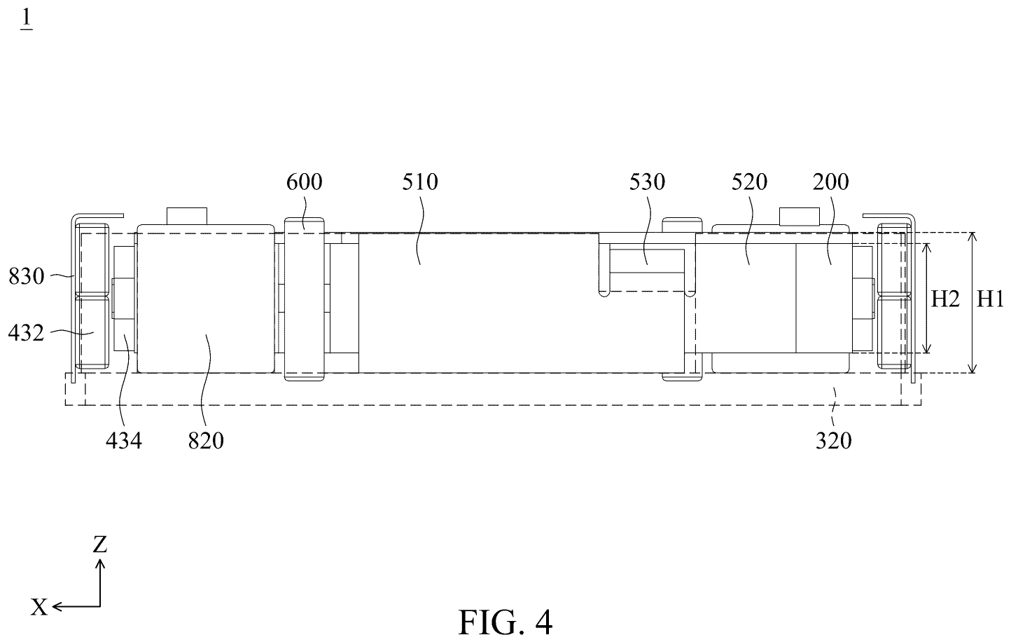

Next, refer to FIG. 4. FIG. 4 is a side view of the optical element driving mechanism 1, according to certain aspects of the present disclosure. For illustrative purposes, the case 310 is removed, and the bottom 320 is shown with a dashed line.

The first part 510 has a height H1, and the second part 520 has a height H2. The height H2 of the second part 520 is smaller than the height H1 of the first part 510. When the second movable part 200 is driven and moved by the driving assembly 300, the second part 520, connected to the second movable part 200, moves with the second movable part 200. The intermediate part 530 bends and moves between the first part 510 and the second part 520. The range of movement of the second part 520 does not exceed the height H1 of the first part 510. That is, the maximum movement range of the second part 520 does not exceed the first part 510.

Next, refer to FIG. 2A and FIG. 5 together. FIG. 5 is a top view of the optical element driving mechanism 1, according to certain aspects of the present disclosure. For illustrative purposes, the case 310 is removed, and the first driving part 410 and the circuit part 420 are shown with dashed lines.

In this embodiment, two guide rods 600 are included. The guide rods 600 are movably connected between the second movable part 200 and the bottom 320 of the fixed part 300. The guide rods 600 are placed between the second movable part 200 and the bottom 320, adjacent to the stabilizing magnetic element 810 and magnetic permeable element 820 of the stabilizing assembly 800.

More specifically, one guide rod 600 is placed between the first groove 210 of the second movable part 200 and the receiving part 322 of the bottom 320, while the other guide rod 600 is placed between the second groove 220 of the second movable part 200 and another receiving part 322 of the bottom 320.

When the second movable part 200 is driven by the driving assembly 300 and moves, the guide rods 600 move between the bottom 320 and the second movable part 200. The V-shape of the first groove 210 allows the guide rod 600 to slide in the Z-axis direction between the groove and the receiving part 322. The U-shape of the second groove 220 allows the guide rod 600 to slide in the Z-axis direction and also roll in the X-axis direction, adjusting the relative position of the second movable part 200 and the bottom 320. As a result, the guide rods 600 allow smooth movement of the second movable part 200 relative to the bottom 320.

It is worth noting that in this configuration, the second movable part 200 has a polygonal structure. In this embodiment, the second movable part 200 may be a rectangle. The guide rods 600 are not positioned at the corners of the second movable part 200 that is rectangular, as corner placement would hinder the movement of the guide rods 600.

The sensing assembly 700 includes a sensing magnetic element 710 (see FIG. 2A) and a sensing element 720. The sensing magnetic element 710 is located on the second movable part 200. The sensing element 720 is positioned on the bottom 320 of the fixed part 300, corresponding to the sensing magnetic element 710. Both the sensing magnetic element 710 and the sensing element 720 are located on the same side of the second movable part 200 as the first groove 210.

Due to the V-shape of the first groove 210, the relative position between the second movable part 200 and the bottom 320 at the first groove 210 is more stable than the relative position at the second groove 220. Therefore, placing the sensing magnetic element 710 and the sensing element 720 on the same side as the first groove 210 helps ensure that the sensing signal when the sensing element 720 detects the first magnetic element 310 is more stable.

Next, please continue to refer to FIG. 2A and FIG. 5. The stabilizing assembly 800 includes a plurality of stabilizing magnetic elements 810, a plurality of magnetic permeable elements 820, and a plurality of magnetic permeable elements 830.

In this embodiment, there are two stabilizing magnetic elements 810 and two magnetic permeable elements 820. The stabilizing magnetic elements 810 are located on the second movable part 200. The magnetic permeable elements 820 are placed on the bottom 320. The stabilizing magnetic elements 810 correspond to the magnetic permeable elements 820. The stabilizing magnetic elements 810 and the magnetic permeable elements 820 provide magnetic attraction along the Y-axis direction to stabilize the movement of the second movable part 200. This helps the second movable part 200 to maintain a stable position relative to the guide rods 600, enabling smooth movement relative to the bottom 320. In this embodiment, two magnetic permeable elements 830 are included. The magnetic permeable elements 830 are positioned at the case 310, corresponding to the driving magnetic elements 432. The magnetic permeable elements 830 provide additional magnetic attraction to stabilize the structure of the second movable part 200.

In summary, the present invention provides an optical element driving mechanism, which includes the first movable part, the second movable part, the fixed part, the driving assembly, the circuit assembly, the guide rods, the sensing assembly, and the stabilizing assembly. The movement of the driving assembly drives the first and second movable parts to move relative to the fixed part, meeting different photographic needs while providing more stable optical quality. Additionally, through the design of the first and second driving parts, the optical element driving mechanism may be compatible with various optical elements (e.g., lenses, aperture modules, etc.).

Moreover, the structural design of the first and second movable parts is compatible with lens of different sizes, enabling the driving mechanism for the first movable part, second movable part, and aperture components to integrate with the aperture module's circuit, simplifying the design of the control circuitry.

Although embodiments of the invention have been shown and described with respect to one or more embodiments, equivalents and modifications will occur to those of ordinary skill in the art upon reading and understanding this specification and the accompanying drawings. Additionally, while particular features of the invention may have been invented with respect to only one embodiment of several embodiments, such features may be combined with one or more of the other embodiments as may be required and advantageous for any given or particular application. Multiple other feature combinations.

Although various embodiments of the present invention have been described above, it should be understood that they are presented by way of example only and not limitation. Various changes may be made in accordance with the embodiments invented herein without departing from the spirit or scope of the invention. Accordingly, the breadth and scope of the present invention should not be limited by any of the above-described embodiments. Rather, the scope of the invention should be defined in accordance with the following claims and their equivalents.

The terminology used herein is for the purpose of describing particular embodiments only and is not intended to be limiting of the invention. As used herein, the singular forms “a, an” and “the” are intended to include the plural forms as well, unless the context clearly indicates otherwise. In addition, the terms “including, includes”, “having, has, with” or variations thereof used in the embodiments and/or patent application scope are intended to be similar to “comprising” is included.

What is claimed is:

1. An optical element driving mechanism, comprising:
a first movable part, for connecting a first optical element;
a fixed part, wherein the first movable part is movable relative to the fixed part; and
a driving assembly, for driving the first movable part to move.

2. The optical element driving mechanism as claimed in claim 1, wherein the driving assembly includes:
a first driving part, driving the first movable part to move in a first dimension; and
a circuit part, electrically connected to the first driving part.

3. The optical element driving mechanism as claimed in claim 2, wherein the first driving part is electrically connected to a first external circuit via the circuit part.

4. The optical element driving mechanism as claimed in claim 2, wherein the first driving part is positioned above the first movable part.

5. The optical element driving mechanism as claimed in claim 2, wherein the circuit part has a connecting circuit, and the connecting circuit is at least partially fixed to the first movable part.

6. The optical element driving mechanism as claimed in claim 5, wherein the circuit part is electrically connected to a second external circuit, and the second external circuit is connected to an optical module, wherein the optical module carries a second optical element.

7. The optical element driving mechanism as claimed in claim 2, further comprising a second movable part, having a polygonal structure, the second movable part is movable relative to the fixed part.

8. The optical element driving mechanism as claimed in claim 7, the driving assembly further includes a second driving part, driving the second movable part to move in a second dimension relative to the fixed part.

9. The optical element driving mechanism as claimed in claim 8, wherein the second driving part is located between the second movable part and the fixed part.

10. The optical element driving mechanism as claimed in claim 7, wherein the first movable part is connected to the second movable part via the first driving part and the circuit part.

11. The optical element driving mechanism as claimed in claim 7, wherein when observed along an incident direction of the incident light, the first driving part and the circuit part are positioned between the first movable part and the second movable part.

12. The optical element driving mechanism as claimed in claim 7, further comprising an electronic component, wherein the electronic component includes:
a first portion, connected to the fixed part;
a second portion, connected to the second movable part; and
an intermediate portion, having a bent shape, spanning across the fixed part, connecting the fixed part and the second movable part.

13. The optical element driving mechanism as claimed in claim 12, wherein when the second movable part moves, the range of movement of the second portion does not exceed the height of the first portion.

14. The optical element driving mechanism as claimed in claim 7, further comprising a plurality of guide rods, wherein the plurality of guide rods are movably connected between the second movable part and the fixed part.

15. The optical element driving mechanism as claimed in claim 14, wherein the second movable part includes:
a first groove, having a V-shaped form, to accommodate one of the guide rods; and
a second groove, having a U-shaped form, to accommodate another one of the guide rods.

16. The optical element driving mechanism as claimed in claim 15, further comprising a sensing assembly, wherein the sensing assembly includes:
a sensing magnetic element, disposed on the second movable part; and
a sensing element, corresponding to the sensing magnetic element, disposed on the fixed part.

17. The optical element driving mechanism as claimed in claim 16, wherein the sensing element, the sensing magnetic element, and the first groove are located on the same side of the second movable part.

18. The optical element driving mechanism as claimed in claim 14, wherein the positions of the guide rods are configured not to be at the corners of the second movable part.

19. The optical element driving mechanism as claimed in claim 6, wherein when observed along a direction perpendicular to an incident direction of the incident light, the first driving part and the circuit part are positioned between the first movable part and the optical module.

20. The optical element driving mechanism as claimed in claim 19, further comprising a second movable part movable relative to the fixed part, wherein when observed along the direction perpendicular to the incident direction of the incident light, the first driving part and the circuit part are positioned between the first movable part, the second movable part, and the optical module.
